(19) United States
(12) Patent Application Publication
(10) Pub. No.: US 2019/0035142 A1
(43) Pub. Date: Jan. 31, 2019

(54) MEASURING APPLIANCE AND METHOD FOR CREATING A 3D MODEL

(71) Applicant: Testo SE & Co. KGaA, Lenzkirch (DE)

(72) Inventors: Jan-Friso Evers-Senne, Titisee-Neustadt (DE); Thomas Schatzle, Biederbach (DE); Patrick Zahn, Titisee-Neustadt (DE)

(73) Assignee: Testo SE & Co. KGaA, Lenzkirch (DE)

(21) Appl. No.: 16/042,210

(22) Filed: Jul. 23, 2018

(30) Foreign Application Priority Data
Jul. 27, 2017 (DE) 102017117056.1

(51) Int. Cl. G06T 15/20; G02B 13/06

(52) U.S. Cl. CPC G06T 15/205; G02B 13/06; H04N 5/23238; G06T 2200/04; G06T 2200/08

(57) ABSTRACT

A measuring appliance (6), having a holding apparatus (10) of variable length, on which an image recording apparatus (9) is arranged at the distal end for the purposes of recording images of an object to be surveyed (1) and at the proximal end (16) of which a display (17) is arranged for real-time presentation of an image from the image recording apparatus (9), wherein an image recording process can be triggered from the proximal end (16) of the holding apparatus.

### INCORPORATION BY REFERENCE

The following documents are incorporated herein by reference as if fully set forth: German Patent Application No. 10 2017 117 056.1, filed Jul. 27, 2017.

### BACKGROUND

The invention describes a measuring appliance having an image recording apparatus for recording images of an object to be surveyed, and a method for creating a 3D model with the aid of this measuring appliance.

For the purposes of creating a 3D model, the manufacture of a multiplicity of images of an object from different positions and different viewing angles, which are used for setting up a system of an equation, is known in order to calculate a three-dimensional model of a recorded object.

The practice of integrating such apparatuses, which are usable for recording the images, into a handheld appliance is known.

However, a problem often arising when creating 3D models of buildings is that the user must stand very close to the object because further objects in the neighborhood prevent increasing the distance to the object to be surveyed.

In this case, regions of the object that are covered from the position of the user on the ground arise, for which no 3D model can be calculated in this case.

In such cases, photographing the building from high positions, too, is known. By way of example, this can be effected from higher stories of an opposite building. However, use can also be made of a hoist, a crane, scaffolding or the like in order to obtain an elevated camera position. However, all these methods are complicated, time-consuming and expensive to implement.

The use of a laser scanner or camera, for example, on an elevated tripod in order to reach non-accessible regions is also known. However, there cannot be a preview in this case, and so the recordings are made “blind”. Moreover, the use of a laser scanner is expensive. Checking the recorded region is not possible in this case, and so recordings may have to be repeated under certain circumstances in a complicated and time-consuming manner.

The use of camera drones is expensive in principle and may be subject to legal restrictions which make the use impossible.

### SUMMARY

The object of the invention lies in creating an apparatus with which buildings can be photographed in a simple and cost-effective manner in order to calculate a 3D model therefrom.

This object is achieved by a measuring appliance and by a method having one or more features of the invention.

In particular, the measuring appliance according to the invention is characterized in that the measuring appliance has a holding apparatus of variable length, in that the image recording apparatus is arranged at the holding apparatus, in that a display for a presentation of an image from the image recording apparatus is arranged at the proximal end of the holding apparatus and in that an image recording process can be triggered from the proximal end of the holding apparatus. Preferably, the presentation is synchronized to an image sequence captured by the image recording apparatus, for example a real-time presentation.

The advantage here is that the user obtains a real-time image from the image recording apparatus in the display, said real-time image being usable for aligning the image recording apparatus. Thus, the display provides the option of checking and determining the image section before an image recording process is triggered.

As a result, the user can align the image recording apparatus in such a way, in particular, that all details for which a 3D model is intended to be produced are visible. Moreover, it is possible to ensure that there is enough overlap between the recorded images such that the individual images are registrable to one another.

Moreover, recording images at heights of up to ten meters is easily possible from the ground. This requires neither permits nor complicated construction work. Moreover, the measuring appliance according to the invention is compact and easily transportable in a normal automobile.

The holding apparatus of variable length can be realized in different ways. By way of example, the holding apparatus can have a plurality of straight elements, such as rods or pipes, which can be plugged into one another. In this way, the length can be changed by simple addition or removal of one or more elements.

The holding apparatus could also be formed in the style of a scissor lift, and so the length is adjustable without carrying along individual parts.

However, it is particularly advantageous if the holding apparatus is embodied as a telescopic rod. As a result, the holding apparatus is compact in the completely retracted state and easily transportable. Nevertheless, the length can be easily adjustable over a very large range, with primarily only the diameter of the holding apparatus changing. In this way, lengths in an entirely extended state of up to four or even six meters are also realizable.

Preferably, the holding apparatus has a locking device in order to secure a set length. This can prevent an unintended change in length during an image recording.

It is particularly advantageous if the telescope extractor is driven by motor, for example by an electric motor. Here, the electric motor or a transmission can provide a sufficient holding torque such that securing in the stationary state is effected automatically.

In order to obtain an operational height that is as high as possible, it is expedient if the image recording apparatus is arranged at the distal end of the holding apparatus.

In an advantageous embodiment of the invention, a datalink exists between the image recording apparatus and the display, image and/or control data being transmittable via said datalink. As a result, it is also possible to transmit control signals, such as those for triggering the image recording, for example, in addition to the real-time presentation of the image data. In particular, the datalink is wired, with a cable, for example for a USB connection, being guided along the holding apparatus.

However, it is particularly advantageous if the datalink has a wireless embodiment. To this end, use can be made of a radio link, for example, such as Bluetooth or WLAN, for example. This is advantageous in that no cable roll or other storage possibility for a cable needs to be provided.

Since the amount of data transferred for a real-time presentation, i.e., a live video stream, is very large, it is advantageous if the image recording apparatus is configured to compress image data and implement a data transmission for the compressed image data via the datalink. This allows the amount of data transmitted to be reduced, as a result of which it is possible to align the image recording apparatus or monitor the alignment thereof in a manner that is as flowing or jerk-free as possible. In this way, the recorded images are also transmittable in a compressed fashion, and so these are likewise controllable by means of the display.

According to a first embodiment of the invention, one or more control signals can also be transferred in addition to the image data for a real-time presentation. By way of example, such a control signal can be the triggering of an image recording process.

An alternative embodiment provides for the image recording apparatus to have a dedicated operating apparatus and for the image content of this operating apparatus to be mirrored onto the display. Here, there is a remote control of the operating apparatus by way of the display.

However, for the purposes of calculating a 3D model, it is advantageous to have as much image information available as possible. Therefore, it is particularly expedient if the image recording apparatus is configured to store the uncompressed image data, in particular in an image data memory. Consequently, it is possible to resort to the raw data of the image recording apparatus for the purposes of calculating the 3D model.

Dedicated operating elements, for example for triggering an image recording process, can be arranged next to the display on the holding apparatus, in particular at the proximal end thereof.

In a preferred embodiment of the invention, the display is configured to control the image recording device, in particular to trigger an image recording process.

The use of a so-called rolling shutter, in which the image sensor is read line-by-line, is widespread in digital cameras. As a result, there is a typical line-by-line offset in the case of camera movements. In the subsequent calculation of the model, this offset can be bothersome and has to be removed by calculation with great outlay.

Therefore, a particularly advantageous embodiment of the invention provides for the image recording apparatus to have a global shutter. In this case, the state of the individual image pixels of the entire image sensor is respectively saved in a background memory element when an image recording process is triggered. These background memory elements are then read and stored as an image. As a result, the line-by-line offset of the rolling shutter is prevented and the image data need not be corrected.

In a further advantageous embodiment, the image recording apparatus has a fisheye lens, as a result of which an image angle that is as large as possible can be captured.

Preferably, the holding apparatus has a handle, which allows good and secure handling. For support purposes, the holding apparatus may also have a shoulder and/or hip strap, for example, so that the load can be carried more easily by the user, in particular in the case of great lengths.

However, it is particularly advantageous if the holding apparatus has a foot for placement on a support. As a result, the load of the measuring appliance is guided in its entirety to the support, for instance the ground. Then, the user can take on only the alignment and guidance.

The embodiment of the holding apparatus as a one-footed telescopic rod, in particular, is advantageous in that the rod can be placed onto the ground and nevertheless still can be provided with a certain freedom to pivot.

This facilitates the alignment of the image recording apparatus such that important details can be recorded without having to retract the telescopic rod. In practice, the user will offset the telescopic rod between the individual image recordings by a fixedly predetermined recommended distance, one meter, for example.

In principle, it is possible for the image recording apparatus to be securely attached to the holding apparatus. Then, the image recording apparatus can be aligned by rotating the holding apparatus. As a result, however, the display is also twisted, and so a user may no longer have a full overview. In an advantageous embodiment of the invention, the display is therefore arranged to be movable, in particular rotatable about the telescopic rod.

In a particularly expedient embodiment of the invention, the holding apparatus has a movably mounted receiving unit for the image recording apparatus and the receiving unit is alignable by a remote controllable, in particular electric and/or hydraulic, drive from the proximal end of the holding apparatus and/or by way of the display. As a result, the image recording apparatus can be swiveled, for example, independently of the holding apparatus. This may be advantageous in certain situations, for instance if the holding apparatus is stationary.

In an advantageous configuration, provision can be made for a distance sensor to be formed, by which a distance from the object is measurable. Consequently, it is possible to obtain scaling information for the 3D model. Consequently, the use of a mark is dispensable. Preferably, the distance sensor is integrated into the image recording apparatus.

Furthermore, the invention also comprises a method for calculating and creating a 3D model using a measuring appliance according to the invention. This method is characterized in that the holding apparatus is set to a first length and at least one image of an object is recorded therewith, in that the holding apparatus is thereupon set to a second length which allows recording of images with sufficient vertical overlap with the first length and images of the object are recorded and in that the length is modified until the object has been recorded in entirety thereof.

In this way, it is possible to very accurately and easily survey objects, in particular buildings, even in large and otherwise inaccessible or covered regions.

In particular, the images recorded at the first length and at the second length are combinable among themselves and/or with further images, recorded without a holding apparatus, for example, for the purposes of calculating the 3D model.

In one configuration, provision can be made for a mark panel to be arranged on the object first, said mark panel being recorded in at least one image and scaling information for the 3D model being obtained therefrom. Consequently, a separate distance measurement is dispensable. Alternatively, the scaling also can be established using a distance sensor, for example the above-described distance sensor, by measuring a distance. The scaling information facilitates the production of a correctly scaled 3D model or the production of a 3D model with a known scale.

In one configuration of the invention, provision can be made for robust and precise image features in the images to be identified and assigned to one another for the purposes of registering the individual images to one another. Here, robust features are advantageous in that they are easily automatically identifiable, while precise features are advantageous in that they define reference points for length measurements. The configuration combines these advantages.

### BRIEF DESCRIPTION OF THE DRAWINGS

The invention is explained in more detail below on the basis of a preferred exemplary embodiment, with reference being made to the attached drawing.

In the FIGURE:

FIG. 1 shows a schematic illustration of a measuring appliance according to the invention in different work positions.

### DETAILED DESCRIPTION

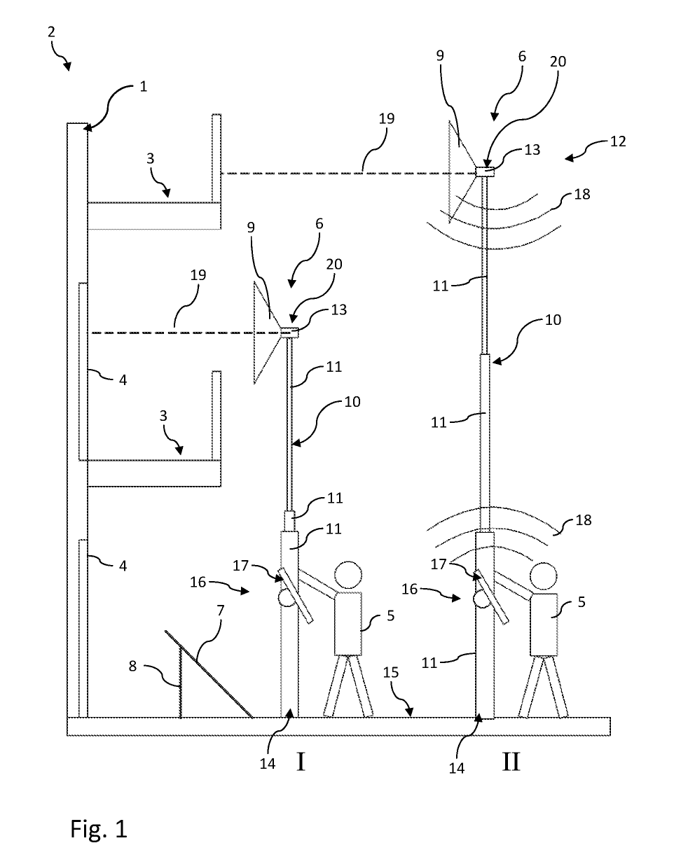

FIG. 1 schematically shows a lateral sectional view of a façade 1 of a building 2 to be surveyed. In the example, the façade 1 shows three stories of the building 2, wherein a balcony 3 is respectively present on the two upper levels and a door 4 is present on all stories.

Furthermore, FIG. 1 shows a user 5 having a measuring appliance 6 according to the invention for capturing the façade 1 in images. A mark panel 7 has been set up in front of the façade 1, said mark panel facilitating and simplifying the scaling of the 3D model created. In the image, the mark panel 7 is held on an oblique stand 8. Naturally, the mark panel 7 can also be aligned parallel to the façade 1 and/or it can also be attached differently.

The measuring appliance 6 has a digital camera 9 as an image recording apparatus. The camera 9 preferably has a fisheye lens and a so-called global shutter which prevents the creation of the typical rolling shutter distortions.

The measuring appliance 6 according to the invention has a telescopic rod 10 as a length-adjustable holding apparatus. In the shown embodiment, the telescopic rod 10 has a plurality of pipe-shaped elements 11, which engage in one another in coaxial fashion. The telescopic rod 10 is continuously adjustable in terms of length by an axial pulling-apart of the individual elements 11. Naturally, other embodiments of the holding apparatus, in which the length adjustment is brought about in a different way, are possible. Therefore, the invention is not restricted to the shown exemplary embodiment.

The telescopic rod 10 preferably can be adjustable by an electric, hydraulic or pneumatic drive, because, firstly, this simplifies the length adjustment and a set length is held automatically.

In the example, a movably mounted receiving unit 13, on which the camera 9 is fastened, is arranged at the distal end 12 of the telescopic rod 10. Using this, it is possible, for example, to pivot the camera 9 horizontally and/or vertically in order to adjust the image section exactly. Alternatively, the camera 9 also can be arranged in a secured manner on the telescopic rod 10. Then, pivoting is only possible by moving the telescopic rod 10.

In the example, the telescopic rod 10 is embodied in such a way that it has a pedestal 14, by which the telescopic rod 10 stands on the ground 15. As a result, a user 5 need not carry the entire weight at all times, and the use is much simplified.

A display 17 is arranged at the proximal end 16, approximately level with the chest of the user 5 in the example. In the example, the display 17 is mounted to be rotatable about a horizontal axis, as a result of which the display 17 is adaptable to users 5 of different height. By way of example, the display 17 also can be a commercially available tablet or a laptop. In particular, the display has a touch sensitive screen (touchscreen).

The camera 9 and the display 17 are each equipped with a radio interface 18 for data transmission. By way of example, this radio interface 18 is embodied as WLAN, which allows a very high data rate and which is implementable in a simple and cost-effective manner. However, other radio protocols, in particular dedicated radio protocols, are also possible.

According to the invention, the camera 9 is configured to allow the image data to be transmitted in compressed fashion and as a live image in real-time to the display 17. As a result, there can be a real-time presentation of the camera image on the display 17. This live image serves for monitoring purposes and for selecting the image section. In this way, the user can record the correct images very easily and quickly.

To this end, the display 17 has at least one trigger apparatus, in the case of the actuation of which by the user 5 a control signal is transmitted via the radio interface 18 to the camera 9, the latter triggering an image recording process there. Thereupon, the camera 9 stores a non-compressed image, for example the raw data of the image sensor. Consequently, this image contains the best possible resolution and detail depth in order to subsequently identify features therein.

The non-compressed images are stored in an image memory within the camera 9. From there, they can be read at a later time. However, it is also possible for the image data to be transmitted in non-compressed form to the display 17 or to a separate calculation unit via the radio interface 18 after the image recording, when no live images are required anymore.

For the purposes of scaling the 3D model, a distance sensor 20 can also be arranged in the image recording apparatus 10 as an alternative or in addition to the mark panel 7, it being possible to determine a distance 19 to the object with said distance sensor. This distance information can be stored with the image raw data and can be used subsequently for scaling purposes.

Surveying the façade 1 and creating a 3D model can be carried out according to the method described below.

Initially, the mark panel 7 is set up in front of the façade 1. The measuring appliance 6 is constructed, with the telescopic rod 10 initially being entirely retracted. Overlapping images of the ground floor are recorded, wherein the mark panel 7 has to be visible in at least one of these images in order to obtain scaling information.

However, the doors 4 to the balconies 3 on the upper levels, for example, are not visible in images that are recorded from the ground.

Therefore, in a second step I, the telescopic rod 10 is set in such a way that the camera 9, in the first upper level, has the door 4 in the field of view via the balcony 3. Here, the length setting and the alignment can be monitored at all times using the live image of the display 17. As soon as the details of interest are in the image, an image is recorded via the trigger on the display 17 and the image is stored as raw data in the camera 9.

Additionally, it is possible to undertake a distance measurement in order to determine the distance 19 to the door.

In a further step, the telescopic rod 10 is lengthened further such that, as shown in II, the balcony 3 of the second upper level is in the image field.

Once all the images have been recorded, the raw image data can be transmitted to the display 17 via the radio interface 18.

Now, the display 17 can have an image processor, by which the 3D model is calculated from the recorded images. This can be carried out using known programs or algorithms.

However, the raw image data also can be read from the camera 9 in a different way or they can be transmitted to a calculation unit.

It is particularly advantageous if robust and precise point or edge features are used for identifying features. Here, robust features are those which can be reliably uniquely identified and assigned to one another in various images by way of algorithms. In this way, the images can be registered to one another. However, these robust features often do not lie at those positions in the images that are of interest to the measuring process.

For this reason, precise features are also determined, said precise features lying at points of interest, for instance at edges that form doors or windows, for example. Precise features can be determined with a very high accuracy in the raw data. By using proficient algorithms and with the aid of the robust features, the precise features, too, can be identified between a plurality of images and thus allow the creation of the 3D model with sub-pixel accuracy.

### LIST OF REFERENCE SIGNS

1 Façade
2 Building
3 Balcony
4 Door
5 User
6 Measuring appliance
7 Mark panel
8 Stand
9 Camera
10 Telescopic rod
11 Element
12 Distal end of the telescopic rod
13 Receiving unit
14 Pedestal
15 Ground
16 Proximal end of the telescopic rod
17 Display
18 Radio interface
19 Distance
20 Distance sensor

1. A measuring appliance (6) comprising:
an image recording apparatus (9) for recording images of an object to be surveyed (1);
a variable length holding apparatus (10), the image recording apparatus (9) is arranged on the holding apparatus (10);
a display (17) for presentation of an image from the image recording apparatus (9) arranged at a proximal end (16) of the holding apparatus (10); and
wherein an image recording process is triggerable from the proximal end (16) of the holding apparatus.

2. The measuring appliance (6) as claimed in claim 1, wherein the holding apparatus comprises a telescopic rod (10).

3. The measuring appliance (6) as claimed in claim 1, wherein the image recording apparatus (9) is arranged at the distal end (12) of the holding apparatus (10).

4. The measuring appliance (6) as claimed in claim 1, further comprising a datalink between the image recording apparatus (9) and the display (17), and at least one of image or control data is transmittable via said datalink.

5. The measuring appliance (6) as claimed in claim 4, wherein the image recording apparatus (9) is configured to compress image data and implement a data transmission for the compressed image data via the datalink (18).

6. The measuring appliance (6) as claimed in claim 1, wherein the image recording apparatus (9) is configured to store the uncompressed image data in an image data memory.

7. The measuring appliance (6) as claimed in claim 1, wherein the display (17) is configured to control the image recording device (9).

8. The measuring appliance (6) as claimed in claim 1, wherein the image recording apparatus (9) has at least one of a global shutter or a fisheye lens.

9. The measuring appliance (6) as claimed in claim 1, wherein the holding apparatus (10) further comprises at least one of a foot (14) for placement on a support (15) or a handle.

10. The measuring appliance (6) as claimed in claim 1, wherein the holding apparatus (10) further comprises a movably mounted receiving unit (13) for the image recording apparatus (9) and the measuring appliance further comprises a remote controllable drive that is adapted to align the receiving unit (13) from the proximal end (16) of the holding apparatus (10) by way of the display (17).

11. The measuring appliance (6) as claimed in claim 1, further comprising a distance sensor (20) on the image recording apparatus (9), by which a distance (19) from the object (1, 3, 4) is measurable.

12. A method for creating a 3D model using a measuring appliance (6) as claimed in claim 1, the method comprising:
setting the holding apparatus (10) to a first length;
recording at least one image of an object (1, 3, 4) with the measuring appliance;
setting the holding apparatus (10) to a second length;
recording of images of the object with a vertical overlap with the at least one image recorded at the first length;
modifying the length of the holding apparatus and recording images of the object until the object has been recorded in an entirety thereof; and
calculating a 3D model from the recorded images.

13. The method as claimed in claim 12, further comprising arranging a mark panel (7) on the object (1) first, recording said mark panel in at least one image, and obtaining scaling information for the 3D model from the at least one image with the mark panel.

14. The method as claimed in claim 12, further comprising identifying image features in the images and assigning the precise image features to one another to register individual ones of the images to one another.
